(19) United States
(12) Patent Application Publication
(10) Pub. No.: US 2026/0356141 A1
(43) Pub. Date: Nov. 12, 2026

(54) TIRE VALVE

(71) Applicant: THE LEGION ENGINEERING CORPORATION, Changhua City, Changhua County (TW)

(72) Inventor: WAYNE-IAN MOORE, Worcestershire (GB)

(21) Appl. No.: 19/384,737

(22) Filed: Nov. 10, 2025

(30) Foreign Application Priority Data
May 9, 2025 (TW) 114117438

(51) Int. Cl. B60C 29/06; B60C 29/00; F16K 15/20

(52) U.S. Cl. CPC B60C 29/066; B60C 29/005; F16K 15/20

(57) ABSTRACT

A tire valve is provided, wherein the tire valve includes: a tubular member including an inner surface, an internal channel defined by the inner surface, and a stem thread; a valve assembly including a seal portion, being movably inserted in the internal channel, and being operable such that the seal portion is able to abut or not abut against the inner surface to block or unblock the internal channel; and a sleeve member including a connection opening, a nut thread screwed to the stem thread, and an outer thread, the sleeve member being configured urge a rim for fastening the tire valve to a rim, the connection opening being in communication with the internal channel, the outer thread being configured to be detachably connected to an inflation device so as to allow the inflation device to be in fluid communication with the connection opening.

### BACKGROUND OF THE INVENTION

### Field of the Invention

The present invention relates to a device for inflation/deflation, particularly to a tire valve.

### Description of the Prior Art

A tire valve is mounted to a rim to allow inflation or deflation. In a conventional tire valve, a valve stem is disposed in a valve seat, and a valve assembly is disposed in the valve stem to control opening or closing of gas flow, thereby enabling the tire to have a certain tire pressure.

According to different standards, one end of the valve stem of a conventional tire valve needs to have a specific standard structure configured to connect to a connector of a standard inflation device. For example, one end of the valve stem of a conventional tire valve needs to have standard threads conforming to a Schrader valve, a Presta valve or an English valve, so as to connect to the connector of an inflation device of a corresponding type. When an inflation device is applied to tire valves of different types, an additional adapter is usually needed to perform inflation.

In addition, the valve stem of a conventional tire valve includes a large diameter section which provides a larger space for the gas flow. The large diameter section passes through the rim and is located outside the rim, and the portion of the valve stem that protrudes outside the rim needs to be fastened by a nut and further needs to include a connection section for connection to an inflation device. This greatly increases the overall length of the conventional valve stem and easily leads to breakage under external forces.

The present invention is, therefore, arisen to obviate or at least mitigate the above-mentioned disadvantages.

### SUMMARY OF THE INVENTION

The main object of the present invention is to provide a tire valve which can be directly connected to an inflation device without any adapter so that inflation can be performed quickly and easily.

To achieve the above and other objects, a tire valve is provided, wherein the tire valve includes: a tubular member including an inner surface, an internal channel and a stem thread, the internal channel being defined by the inner surface; a valve assembly including a seal portion, being movably inserted in the internal channel, and being operable such that the seal portion abuts against the inner surface to block the internal channel, or such that the seal portion does not abut against the inner surface to unblock the internal channel; and a sleeve member including a connection opening, a nut thread and an outer thread, the nut thread being screwed to the stem thread, the sleeve member being configured to urge a rim so as to fasten the tire valve to the rim, the connection opening being in communication with the internal channel, the outer thread being configured to be detachably connected to an inflation device so as to allow the inflation device to be in fluid communication with the connection opening.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIGS. 3 and 4 are radial cross-sectional views of an exemplary embodiment of the present invention;

FIG. 5 is an axial cross-sectional view of an exemplary embodiment of the present invention;

FIG. 6 is another exploded view of an exemplary embodiment of the present invention; and

FIG. 7 is a schematic diagram showing a tire valve mounted to a rim according to an exemplary embodiment of the present invention.

### DETAILED DESCRIPTION OF THE PREFERRED EMBODIMENTS

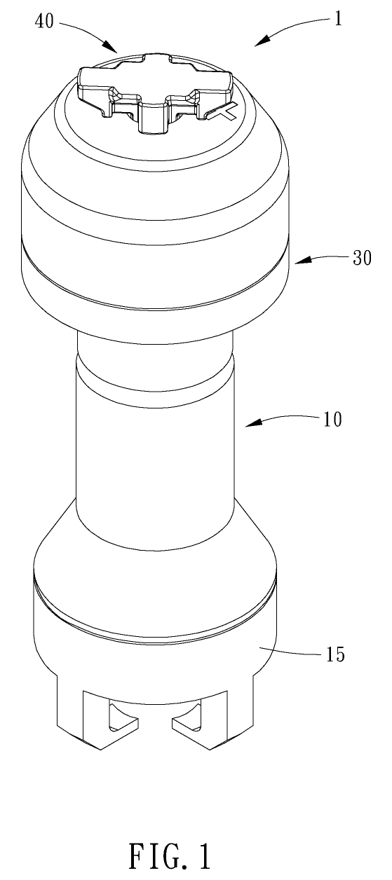

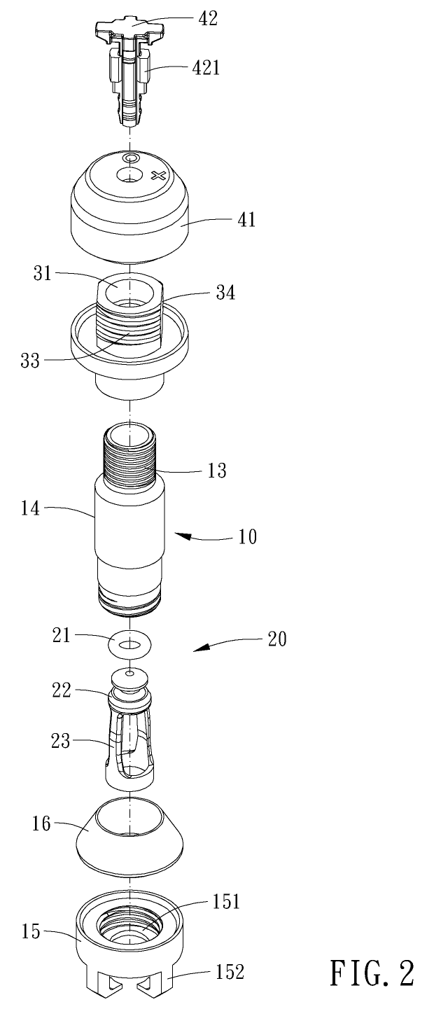

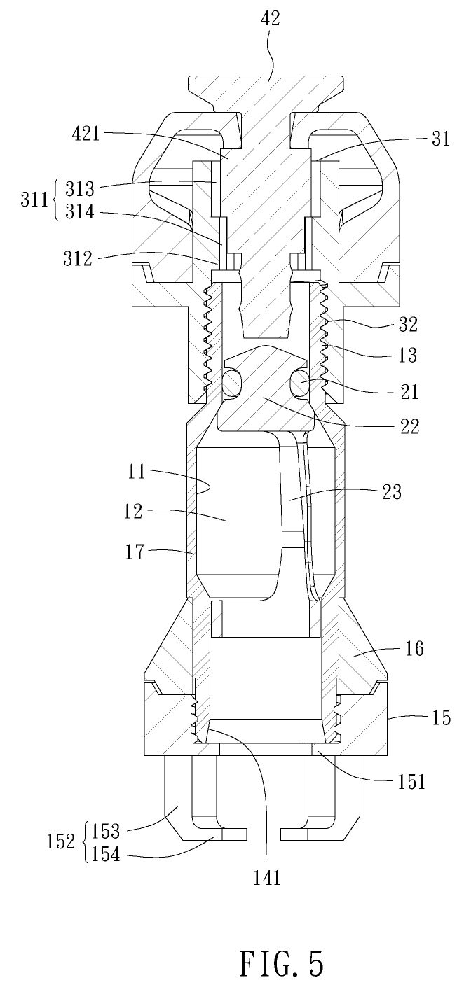

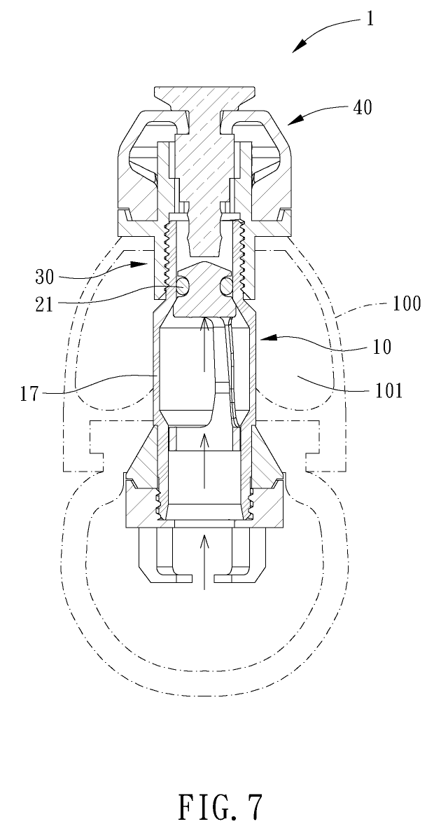

Please refer to FIGS. 1-7 for an exemplary embodiment of the present invention. A tire valve 1 of the present invention includes a tubular member 10, a valve assembly 20 and a sleeve member 30.

The tubular member 10 includes an inner surface 11, an internal channel 12 and a stem thread 13, and the internal channel 12 is defined by the inner surface 11. The valve assembly 20 includes a seal portion 21. The valve assembly 20 is movably inserted in the internal channel 12. The valve assembly 20 is operable such that the seal portion 21 abuts against the inner surface 11 to block the internal channel 12, or such that the seal portion 21 does not abut against the inner surface 11 to unblock the internal channel 12. The sleeve member 30 includes a connection opening 31, a nut thread 32 and an outer thread 33. The nut thread 32 is screwed to the stem thread 13. The sleeve member 30 is configured to directly or indirectly urge a rim 100 so as to fasten the tire valve 1 to the rim 100. The connection opening 31 is in communication with the internal channel 12. The outer thread 33 is configured to be detachably connected to an inflation device so as to allow the inflation device to be in fluid communication with the connection opening 31. Accordingly, the tire valve 1 does not require any adapter and, through the outer thread 33, can be directly connected to the inflation device to perform inflation quickly and easily.

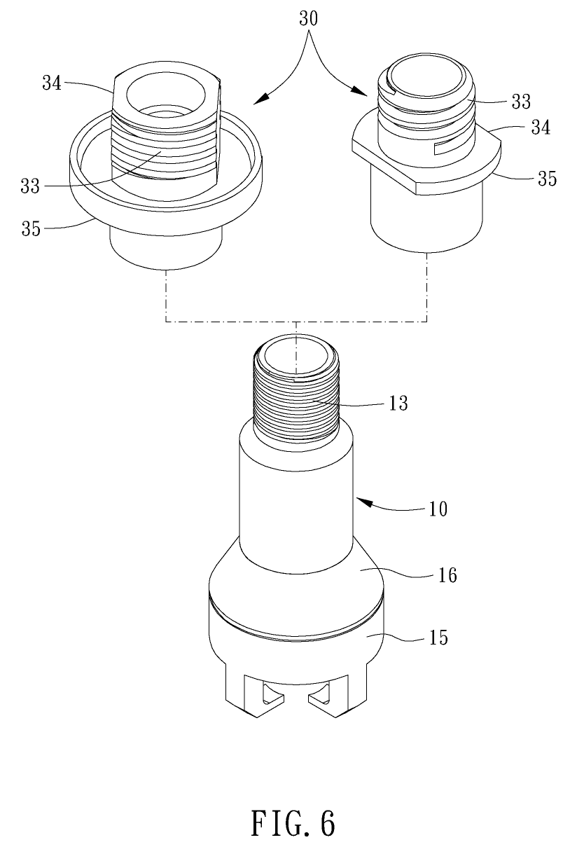

For example, the tire valve 1 may be an American valve or a Schrader valve, a Presta valve (FIG. 6), an English valve, or other ones. The tubular member 10 may be integrally formed of one piece or a multi-piece assembly. The tubular member 10 may include a valve body and a valve stem. The valve body and the valve stem may be integrally formed of one piece, the valve body is a portion connected to a rim, and the valve stem is a portion connected to the valve body and protrudes to the outside of the rim.

In this embodiment, the tubular member 10 further includes the valve stem 14, an end cap 15 and an elastic sealing ring 16. The valve stem 14 includes the stem thread 13. The end cap 15 is screwed to an end portion of the valve stem 14, which facilitates assembly/disassembly and replacement. The elastic sealing ring 16 is sleeved on the valve stem 14 and clamped between the valve stem 14 and the end cap 15 to provide good airtightness. The end cap 15 includes an inner flange 151. The valve stem 14 abuts axially against the inner flange 151, and the valve assembly 20 is movable to be axially stopped by the inner flange 151, thereby providing reliable support and anti-detachment.

Specifically, the valve assembly 20 further includes a body portion 22 and a plurality of legs 23. The seal portion 21 is disposed on the body portion 22. The plurality of legs 23 extend outwardly from the body portion 22 and are axially stoppable by the inner flange 151, providing multi-point stable support. End portions of the plurality of legs 23 may be interconnected to provide good structural strength.

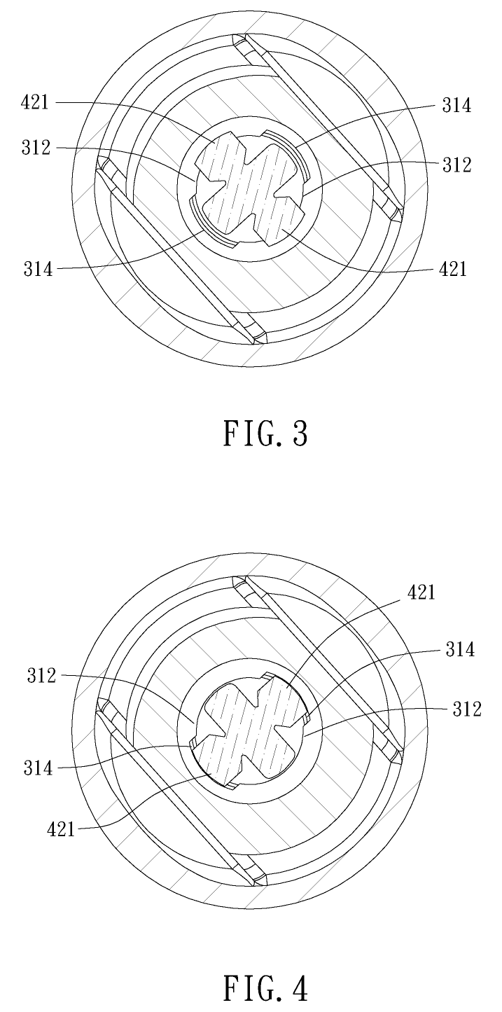

Preferably, the tire valve 1 further includes a deflation assembly 40. An inner surface of one of the valve stem 14 and the sleeve member 30 includes a recessed structure 311 and at least one projection 312 protruding radially from the recessed structure 311. The deflation assembly 40 includes an exhaust cap 41 disposed on the sleeve member 30 and a rod member 42 movably penetrating through the exhaust cap 41. The rod member 42 includes at least one radial protrusion 421. When the at least one radial protrusion 421 axially corresponds to the at least one projection 312 (FIG. 3), the rod member 42 is not capable of pushing the valve assembly 20 to unblock the internal channel 12. When the at least one radial protrusion 421 does not axially correspond to the at least one projection 312 (FIG. 4), the rod member 42 is capable of pushing the valve assembly 20 to unblock the internal channel 12, thereby enabling simple and rapid deflation.

In this embodiment, the recessed structure 311 is disposed on the inner surface of the sleeve member 30. The recessed structure 311 includes an annular groove 313 and at least one (preferably a plurality of) longitudinal groove 314. The at least one longitudinal groove 314 and the at least one projection 312 are circumferentially adjacent to each other, and the at least one longitudinal groove 314 extends axially inward from the annular groove 313. Depending on different types or sizes of rims, the rod member 42 may be designed to have a corresponding suitable length, or may cooperate with another component to provide a larger applicable range. When the at least one radial protrusion 421 corresponds to the at least one longitudinal groove 314, the rod member 42 is capable of pushing the valve assembly 20 to unblock the internal channel 12.

The tubular member 10 further includes a large diameter section 17, and the internal channel 12 extends through the large diameter section 17. When the tubular member 10 is inserted through the rim 100, the large diameter section 17 enters in an internal room 101 of the rim 100, and the position where the seal portion 21 abuts against the inner surface 11 is located within the internal room 101 of the rim 100. Therefore, unlike conventional tire valves where the large diameter section is located outside the rim, the overall length of the tire valve of the present invention is greatly reduced and the risk of breakage is lowered.

The seal portion 21 may be a part of the body portion 22 or a sealing member additionally disposed on the body portion 22. The valve assembly 20 may also, by another portion of the body portion 22 (for example, a radial flange of a larger diameter formed beneath the sealing member) or by the sealing member disposed on the body portion 22, be stopped by the inner surface 11 of the tubular member 10 (for example, by an inwardly tapered surface of the large diameter section).

The end cap 15 includes a plurality of extension arms 152. Each of the plurality of extension arms 152 includes a first section 153 and a second section 154. The first section 153 extends outward from the inner flange 151, and the second section 154 extends radially inward from the first section 153. End portions of the plurality of extension arms 152 are spaced apart from one another, which facilitates assembly of the valve assembly 20 and allows various driving tools to drive the end cap 15 for assembly/disassembly. Preferably, an end portion of the valve stem 14 includes an inner inclined surface 141. The inner inclined surface 141 expands gradually in the direction toward the inner flange 151, which facilitates assembly/disassembly of the valve assembly 20 and allows smooth movement of the valve assembly 20.

An outer circumferential wall of the sleeve member 30 includes a plurality of cut surfaces 34. The plurality of cut surfaces 34 are configured for engagement with a driving tool (such as a wrench, pliers, or a similar tool) to drive the sleeve member 30, thereby facilitating assembly/disassembly, replacement, and maintenance. The sleeve member 30 further includes at least one (preferably a plurality of) outer shoulder 35. The at least one outer shoulder 35 is configured to urge the rim 100 to fasten the tire valve. In other embodiments, the at least one outer shoulder 35 may be part of the outer thread 33 of the sleeve member 30.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tire valve including:
a tubular member including an inner surface, an internal channel and a stem thread, the internal channel being defined by the inner surface;
a valve assembly including a seal portion, being movably inserted in the internal channel, and being operable such that the seal portion abuts against the inner surface to block the internal channel, or such that the seal portion does not abut against the inner surface to unblock the internal channel; and
a sleeve member including a connection opening, a nut thread and an outer thread, the nut thread being screwed to the stem thread, the sleeve member being configured to urge a rim so as to fasten the tire valve to the rim, the connection opening being in communication with the internal channel, the outer thread being configured to be detachably connected to an inflation device so as to allow the inflation device to be in fluid communication with the connection opening.

2. The tire valve of claim 1, wherein the tubular member further includes a valve stem, an end cap and an elastic sealing ring, the valve stem includes the stem thread, the end cap is screwed to an end portion of the valve stem, and the elastic sealing ring is sleeved on the valve stem and clamped between the valve stem and the end cap.

3. The tire valve of claim 2, wherein the end cap includes an inner flange, the valve stem abuts axially against the inner flange, and the valve assembly is movable to be axially stopped by the inner flange.

4. The tire valve of claim 3, wherein the valve assembly further includes a body portion and a plurality of legs, the seal portion is disposed on the body portion, and the plurality of legs extend outwardly from the body portion and are axially stoppable by the inner flange.

5. The tire valve of claim 2, further including a deflation assembly, wherein an inner surface of one of the valve stem and the sleeve member includes a recessed structure and at least one projection protruding radially from the recessed structure, the deflation assembly includes an exhaust cap disposed on the sleeve member and a rod member movably penetrating through the exhaust cap, the rod member includes at least one radial protrusion, when the at least one radial protrusion axially corresponds to the at least one projection, the rod member is not capable of pushing the valve assembly to unblock the internal channel, and when the at least one radial protrusion does not axially correspond to the at least one projection, the rod member is capable of pushing the valve assembly to unblock the internal channel.

6. The tire valve of claim 5, wherein the recessed structure includes an annular groove and at least one longitudinal groove, the at least one longitudinal groove and the at least one projection are circumferentially adjacent to each other, and the at least one longitudinal groove extends axially inward from the annular groove.

7. The tire valve of claim 3, wherein the end cap includes a plurality of extension arms, each of the plurality of extension arms includes a first section and a second section, the first section extending outward from the inner flange, the second section extending radially inward from the first section, and end portions of the plurality of extension arms are spaced apart from one another.

8. The tire valve of claim 3, wherein the end portion of the valve stem includes an inner inclined surface, and the inner inclined surface expands gradually in a direction toward the inner flange.

9. The tire valve of claim 1, wherein an outer circumferential wall of the sleeve member includes a plurality of cut surfaces, and the plurality of cut surfaces are configured for engagement with a driving tool to drive the sleeve member.

10. The tire valve of claim 1, wherein the sleeve member further includes at least one outer shoulder, and the at least one outer shoulder is configured to urge the rim to fasten the tire valve.
